(19) United States
(12) Patent Application Publication
(10) Pub. No.: US 2013/0047752 A1
(43) Pub. Date: Feb. 28, 2013

(54) Dual Function Liquid Sampler

(71) Applicant: John Linderman, Wilton, CT (US)

(72) Inventor: John Linderman, Wilton, CT (US)

(21) Appl. No.: 13/598,740

(22) Filed: Aug. 30, 2012

Related U.S. Application Data
(60) Provisional application No. 61/528,866, filed on Aug. 30, 2011.

(51) Int. Cl. G01N 1/14; B23P 17/04; B32B 37/02

(52) U.S. Cl. 73/864.61; 156/281; 29/428

(57) ABSTRACT

In one embodiment, a fluid sampling apparatus is disclosed. The apparatus includes an inlet that is fluidically linked to a vacuum compartment through a one-way intake valve and a storage compartment that is fluidically linked to the vacuum compartment through a one-way exit valve; and a plunger for intaking a sample through the inlet into the vacuum compartment and then pushing the sample into the storage compartment. A method of fabrication and use are provided.

### CROSS REFERENCE TO RELATED APPLICATIONS

This application is filed under 35 U.S.C. §111(a), and claims priority under 35 U.S.C. §119(e) to U.S. Provisional Patent Application No. 61/528,866 filed Aug. 30, 2011.

### BACKGROUND OF THE INVENTION

1. Field of the Invention

The invention disclosed herein relates to methods and apparatus for liquid sampling with a dual function liquid sampling apparatus that both draws a liquid sample and then functions as the primary packaging container for postal shipment of the collected liquid sample. The apparatus of the present invention is particularly suitable for sampling and shipment of engine oil from a crank case.

2. Description of the Related Art

The collection and subsequent testing of engine oil samples is a procedure that is recognized as being critical for optimizing both engine performance and establishing economical replacement schedules for lubricant oils. The testing process determines the physical and chemical properties of the oil with a particular focus on contaminants such as engine oil degradates, metals from the engine, and fluids from systems associated with engine operation. The test results provide valuable information related to maintenance, operation and provide early indication of potential problems.

Several types of liquid samplers are known in the prior art. U.S. Pat. No. 7,938,029 discloses an oil sampling assembly structured to collect an oil sample from the oil circulating system of an engine or other device and including a housing connected in fluid communication with the oil circulating system and having a container removably connected thereto. Unfortunately, usage of this assembly requires significant structural modification in order to connect the sampling assembly to an engine or other machinery. In the case of automobiles, it would not be appropriate or permissible to make such an installation.

U.S. Pat. No. 7,082,848 relates to a method of transferring a representative fluid sample from a pressurized source into a sample bottle. However, this method requires that the fluid being sampled is flowing through a pressurized circuit. This makes the method inapplicable to sampling of automotive fluids such as engine oil, transmission fluid, and brake oil.

The fluid sampler disclosed in U.S. Pat. No. 5,370,005 is also designed for use with pressurized systems.

U.S. Pat. No. 5,341,691 discloses a dual use pressurized and unpressurized oil sampling apparatus. The apparatus provides for taking samples from either pressurized or non-pressurized oil sources. The oil sampling apparatus includes a body configured to define a conduit therethrough, a vacuum passageway defined to extend through the body in fluid communication with the conduit, and a pressurized oil passageway defined to extend through the body in fluid communication with the conduit. The body further defines a rigid tube having a tube interior connectable between a source of pressurized oil and the pressurized oil passageway. The apparatus further includes a positionable sample bottle. The dual use capability disclosed is associated with relatively higher mechanical complexity and product cost.

The liquid sampler disclosed in U.S. Pat. No. 5,193,404 uses negative air pressure to draw a liquid sample into a sample bottle. After sample collection is complete, the sample bottle has to be disconnected from the sampler and separately prepared for shipping. The liquids sampler disclosed in U.S. Pat. No. 4,930,360 is a similar apparatus and does not include features that facilitate postal shipping of the liquid sample after it has been collected.

U.S. Pat. No. 4,925,627 describes an oil sampling device that uses the negative pressure in an evacuated receptacle to draw an oil sample. A disadvantage of this type of device is the risk of partial loss vacuum in the receptacle and consequent inability of the residual vacuum to draw a quantity of sample sufficient for subsequent analysis. Loss of vacuum can occur for a number of reasons including leakage during storage, premature opening of the vacuum closure and concomitant ingress of atmospheric air, and volatiles in the oil sample that can generate partial pressure in the evacuated space.

The gear case oil sampler disclosed in U.S. Pat. No. 4,580,453 uses negative air pressure to draw an oil sample. However, use of this device requires the permanent installation of a sampling port on the gear case. The drilling of an access port on the gear case is unlikely to be an acceptable option for automobile manufacturers and owners.

The oil sampling system of U.S. Pat. No. 4,548,088 uses negative air pressure, created by a pump mechanism, to draw oil into a collection bottle. After sample collection is completed, the collector has to be detached from a head assembly then separately prepared for transfer to a testing laboratory.

In view of the prior art, a need exists for a compact, convenient, and economical liquid sampling apparatus which functions both as a sample collector and the primary packaging container requiring minimal secondary packaging for postal shipment of the liquid sample to appropriate testing locations.

### BRIEF SUMMARY OF INVENTION

In one embodiment, a fluid sampling apparatus is disclosed. The apparatus includes an inlet that is fluidically linked to a vacuum compartment through a one-way intake valve and a storage compartment that is fluidically linked to the vacuum compartment through a one-way exit valve; and a plunger for intaking a sample through the inlet into the vacuum compartment and then pushing the sample into the storage compartment.

In another embodiment, a method for fabricating a sampler is provided. The method includes fabricating a first piece and at least a second piece; and joining the first piece and the second piece to provide the sampler, the sampler including an inlet that is fluidically linked to a vacuum compartment through a one-way intake valve and a storage compartment that is fluidically linked to the vacuum compartment through a one-way exit valve; and a plunger for intaking a sample through the inlet into the vacuum compartment and then pushing the sample into the storage compartment.

Additionally, in another embodiment, a method for sampling a fluid is provided. The method includes selecting a sampler that includes an inlet that is fluidically linked to a vacuum compartment through a one-way intake valve and a storage compartment that is fluidically linked to the vacuum compartment through a one-way exit valve, and a plunger for intaking a sample through the inlet into the vacuum compartment and then pushing the sample into the storage compartment; upstroking the plunger to intake the sample; and downstroking the plunger to push the sample into a storage compartment.

### BRIEF DESCRIPTION OF DRAWINGS

The features and advantages of the invention are apparent from the following description taken in conjunction with the accompanying drawings in which:

FIG. 1 is an exploded perspective view of an oil sampler apparatus, illustrating a main body equipped with a manually operated plunger mechanism for drawing an oil sample via a flexible tube that forms a fluid-tight seal with an inlet port on the main body and includes an attached clip for guiding the correct depth of insertion of the flexible tube into crankcase of engine. FIG. 1 also illustrates a perspective view of a postal shipment carrier, an integral part of the apparatus, which enables the sampled oil to be shipped by post to locations where the oil may be tested for diagnostic purposes;

FIG. 2 is a cross sectional view of the of the oil sampler apparatus illustrated in FIG. 1;

FIG. 3 is an assembled view of the oil sampler apparatus illustrated in FIG. 1;

FIG. 4 is an exploded view that shows the details of the valve assembly at the base of the first compartment (“vacuum compartment”) of the apparatus where an oil sample is initially drawn in by an upstroke of the plunger and then transferred to the second compartment (“storage compartment”) by a down stroke of the plunger;

FIG. 5 is an unfolded view of postal shipment carrier illustrated in FIG. 1.

### DETAILED DESCRIPTION OF THE INVENTION

Disclosed herein is a dual function oil sampling apparatus and related methods. Generally, the dual function oil sampling apparatus initially functions as sample collector and subsequently as an approved postal shipping container for liquids.

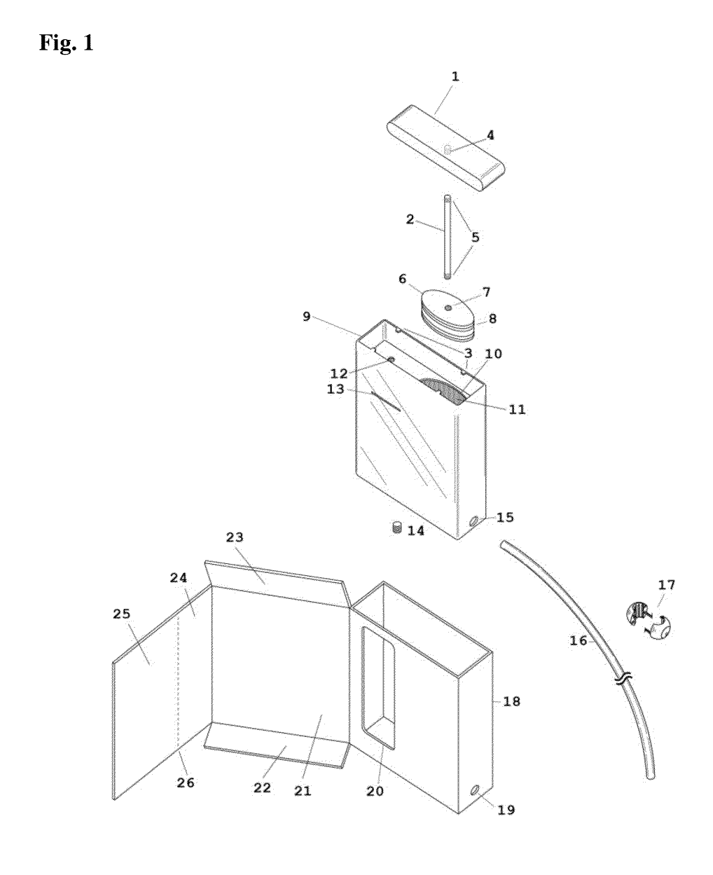

FIG. 1 shows an exploded view of a main body 9 of the apparatus (referred to as a “sampler” 100) and an outer containment structure 18 (also referred to as a “carrier,” or “carrier box”).

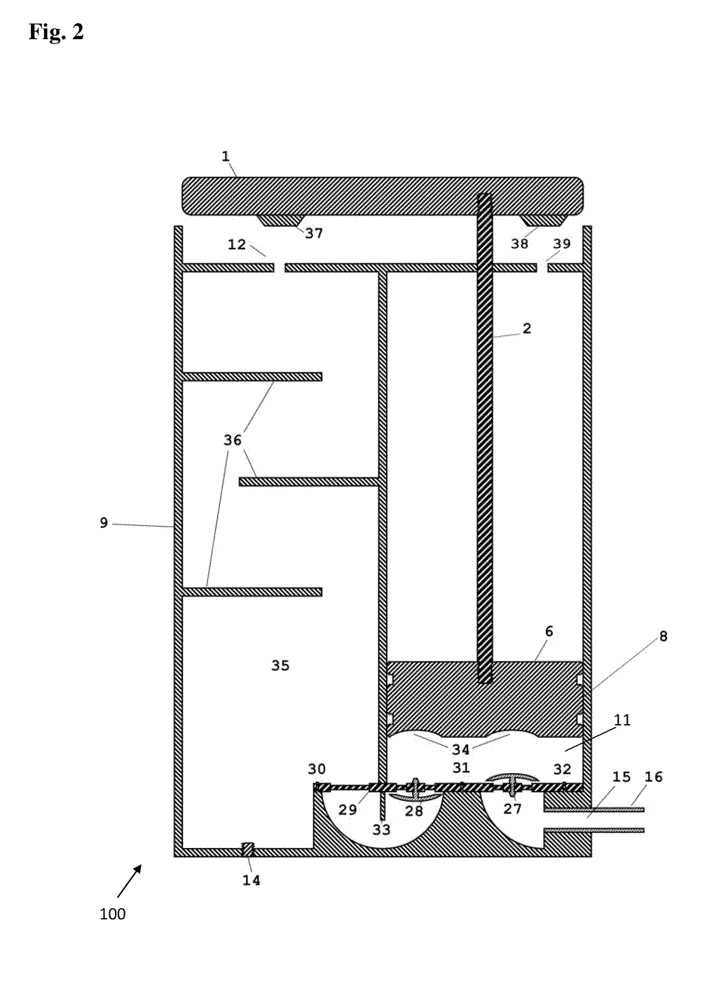

FIG. 2 shows a vertical cross section view of the sampler 100 which includes two compartments, a vacuum compartment 11 and storage compartment 35 (See FIGS. 1 and 2). The vacuum compartment 11 has an ellipsoidal horizontal cross section and is equipped with a manually operated plunger mechanism (“plunger”) that includes a plunger head 6, conforming to the inner dimensions of the vacuum compartment 11, a cylindrical plunger shaft 2 and a plunger handle 1. The plunger shaft 2 has threaded ends 5 that are screwed into matching threaded holes 4 and 7, on the plunger handle 1 and plunger head 6, respectively.

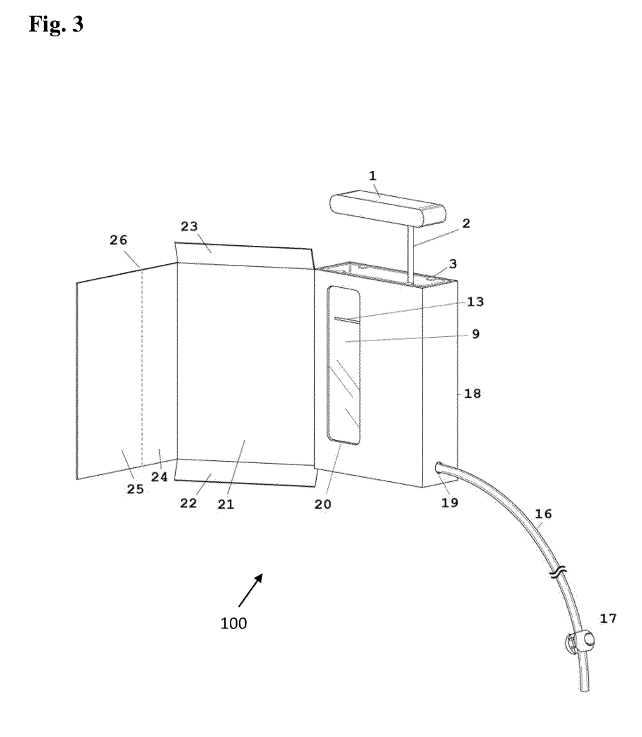

FIG. 3 provides a perspective view of the sampler 100 when it is assembled to withdraw a sample of oil from a source, such as the crankcase of an engine.

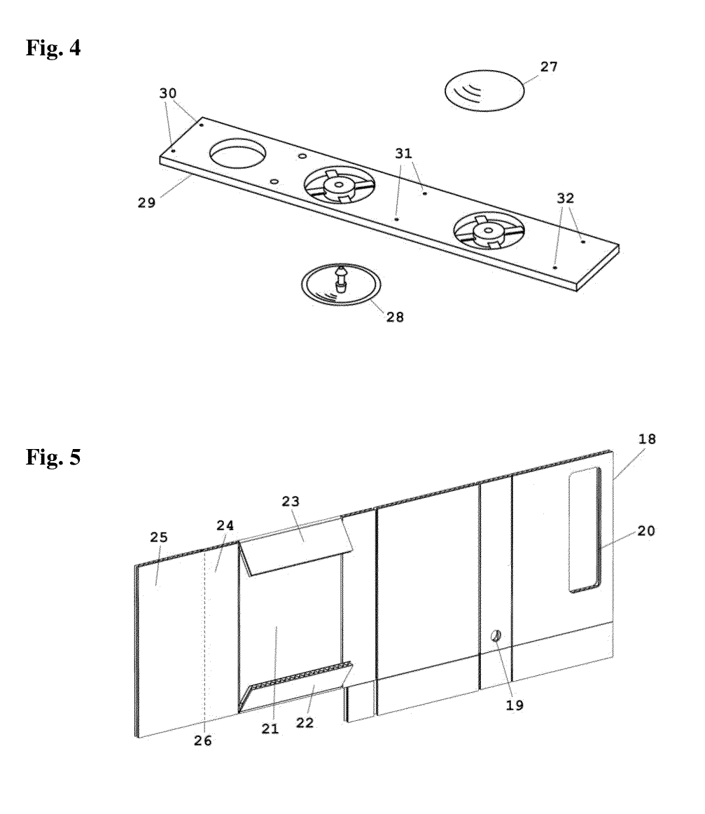

Circumferential ridges 8 on a vertical side of the plunger head 6 fluidically seal it against the walls of the vacuum compartment 11 to provide a desired pressure gradient. The plunger head 6 may include a sealing material, such as a rubber gasket disposed thereabout. The base of the vacuum compartment 11 is equipped with a platform structure (shown in FIG. 2, and in more detail in FIG. 4) that extends into the adjoining storage compartment 35 and fluidically links inlet port 15, a one-way intake valve 27 and a one-way exit valve 28 that directs liquid from the vacuum compartment 11 into the storage compartment 35. These one-way valves (commonly referred to as “umbrella valves”) are accommodated on a board 29 (FIG. 4) that is affixed to the base platform using appropriately positioned pinholes and pins on the board and base platform, respectively. The one-way valves incorporate an umbrella type mechanism and their appropriate orientation causes fluid flow to be limited to the desired direction (FIGS. 2 and 4). An air vent 39 is provided at the top of the vacuum compartment 11 to allow the air space above the plunger head 6 to maintain equality with ambient pressure.

In the embodiment shown, the one-way valves 27, 28 are mutually opposing. As a result, withdrawing the plunger provides for intaking (e.g., pulling) a sample into the vacuum compartment 11 through the one-way intake valve 27. Subsequent insertion of the plunger directing (i.e., pushing) the sample from the vacuum compartment 11 through the one-way exit valve 28 into the storage compartment 35.

The storage compartment 35 of the sampler (FIG. 2) is fluidically linked to the vacuum compartment 11 via the one-way valve 28. The storage compartment 35 may be equipped with baffles 36, which enhance mechanical strength and dampen oscillation of liquid contents, an air vent 12 that allows egress of air displaced by fluid entry into the storage compartment 35, and a threaded drain plug 14 for removing liquid contents of the storage compartment 35. A horizontal mark 13 (“fill line”) that is appropriately located on the outside surface of the translucent or transparent body of the sampler indicates the level of liquid in the storage compartment 35.

Referring now also to FIGS. 1, 3 and 5, the containment structure 18 (carrier box 18), preferably constructed from cardboard-like material, is provided with an opening 19 that coincides with inlet port 15 of the sampler, and another opening 20 that is window-shaped to provide appropriate framing of fill line 13 (FIG. 3). Additionally, the carrier box 18 has a configuration of flaps and panels (FIG. 5) that enable effective closure, as well as providing for display of information such as product identity and directions for sampling and postal shipment of the sampler 100.

The sampler 100 may be used to collect a sample of engine oil. In one example, an appropriate length of flexible tubing 16 is inserted through opening 19 to engage, in a fluidically sealed way, with inlet port 15 (FIG. 3). The other end of the flexible tubing 16 is inserted into the dipstick port of an engine until the indicator clip 17 on the flexible tubing 16 is coincident with the top of the dipstick port. The top of the carrier box 18 is then accessed to access the plunger handle 1. An upstroke of the plunger causes formation of a partial vacuum in the air space, below the plunger head 6, in the vacuum compartment 35. As a result, an aliquot of oil is drawn into this partially evacuated air space, via the flexible tubing 16, through inlet port 15 and one-way intake valve 27. At the same time, valve 28 remains closed, and the air above the plunger head is expelled through air vent 39. A down stroke of the plunger pushes the oil aliquot through valve 28 into the storage compartment 35. In the course of the down stroke, intake valve 27 remains closed and air displaced by entry of oil into the storage chamber exits through air vent 12. The up and down cycle of the plunger is repeated until a sufficient amount of oil has been drawn into the storage compartment, as indicated by viewing the oil level and fill line 13 through window 20.

The sampler 100, once loaded with a sufficient quantity of sampled oil, may be prepared for postal shipment. In one example, the flexible tubing 16 is detached from the apparatus and the plunger is pushed down until the plunger head 6 engages with the tabs 3 in the recess that spans the top of the sampler 100. In this “locked down” position of the plunger, appropriately positioned elastomer beads 37 and 38, under the plunger handle 1, seal the air vents of the storage compartment 35 and the vacuum compartment 11, respectively. In some embodiments, the flexible tubing 16 may be removed and the inlet 15 may then be sealed to prevent leakage of any residue or intrusion of foreign material.

The sampler 100 includes the carrier box 18 which may be provided at least partially mounted onto the main body 9. Generally, the carrier box 18 includes a front panel 25, at least one side panel 24, and a rear panel 21. A top flap 23 and a bottom flap 22 are included in the carrier box 18 to provide for a complete enclosure of the main body 9. At least a portion of the interior surfaces of the panels (21, 24, 25) may include a contact cement to provide for adhesion of the carrier box 18 to the main body 9.

Once the plunger is locked down, the top flap 23 of the carrier box 18 is then closed by appropriately engaging the flaps (FIG. 3) to effect closure. The front panel 25 is detached at perforated line 26 to leave one of the side panels 24 which has dimensions that match those of the smaller sides of the main body 9. Panels 21 and 24 are then folded into place, over the panels with the window and access port, respectively, and secured with adhesive placed on the contact side of the panel 24. The top flap 23 and the bottom flap 22 are then folded and secured with adhesive tape to close the carrier box 18. Appropriate addressee and sender information may then be affixed to the visible side of panel 21, and the carrier box and contents placed in a transparent envelope and mailed.

The sampler 100 may be fabricated by use of conventional techniques, such as injection molding of the main body 9. For example, the main body 9 may be molded as a first piece and a second piece (not shown). The board 29 may be affixed within one of the first piece and the second piece, with the pieces subsequently being joined together. The joining may be accomplished with a variety of conventional techniques, such as bonding, gluing, melting, riveting and fastening. Once joined, the respective compartments and other features within the sampler 100 are sealed from one another. An intermediate gasket may be included between the first piece and the second piece to ensure fluidic sealing of the compartments.

Materials used in the construction of the sampler 100 may include any materials deemed appropriate. Generally, materials used in construction of the main body 9 include materials that are compatible with fluids to be sampled. By way of example, a variety of plastics may be used in construction of the main body 9 and other components (as appropriate).

Thus, the teachings herein result in a compact, convenient, and economical liquid sampling apparatus which functions both as a sample collector and primary packaging container. The primary packaging container requires minimal secondary packaging for postal shipment of the liquid sample.

It should be recognized that the teachings herein are merely illustrative of the best mode and are not limiting of the invention. Further, one skilled in the art will recognize that additional components, configurations, arrangements and the like may be realized while remaining within the scope of this invention. Generally, design and/or applications of the sampling system are limited only by the needs of a system designer, manufacturer, operator and/or user and demands presented in any particular situation.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including,” “has” and “having” are intended to be inclusive such that there may be additional elements other than the listed elements.

Where used herein, the term “shipment” and similar terms should be construed as transfer of the apparatus to a third party, wherein handling of the apparatus proceeds without requirement for or application of any special handling protocols. Accordingly, the term “shipment” and other similar terms are not meant to imply any particular standards of performance.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention but to be construed by the claims appended herein.

What is claimed is:

1. A fluid sampling apparatus comprising:
an inlet that is fluidically linked to a vacuum compartment through a one-way intake valve and a storage compartment that is fluidically linked to the vacuum compartment through a one-way exit valve;
and a plunger for intaking a sample through the inlet into the vacuum compartment and then pushing the sample into the storage compartment.

2. The apparatus of claim 1, wherein the plunger comprises a seal to provide a desired pressure gradient.

3. The apparatus of claim 2, wherein the seal comprises at least one of a ridge and a sealing material.

4. The apparatus of claim 1, wherein at least one of the vacuum compartment and the storage compartment comprise a vent to equalize pressure with the atmosphere.

5. The apparatus of claim 4, wherein a head of the plunger comprises at least one seal, each of the seals configured to seal a respective vent.

6. The apparatus of claim 1, further comprising at least one internal baffle configured to strengthen a body of the apparatus.

7. The apparatus of claim 1, wherein the inlet is configured for coupling with a sampling tube.

8. The apparatus of claim 7, wherein the sampling tube comprises a depth indicator disposed thereon.

9. The apparatus of claim 1, further comprising a carrier box configured to provide an envelope around a body of the apparatus.

10. The apparatus of claim 9, wherein the carrier box comprises an adhesive on at least one interior surface.

11. The apparatus of claim 9, wherein the carrier box is adapted for use as a mailing label.

12. A method for fabricating a sampler, the method comprising:
fabricating a first piece and at least a second piece; and
joining the first piece and the second piece to provide the sampler, the sampler comprising an inlet that is fluidically linked to a vacuum compartment through a one-way intake valve and a storage compartment that is fluidically linked to the vacuum compartment through a one-way exit valve;
and a plunger for intaking a sample through the inlet into the vacuum compartment and then pushing the sample into the storage compartment.

13. The method as in claim 12, wherein the fabricating comprises molding at least one of the first piece and the at least a second piece.

14. The method as in claim 12, wherein the joining comprises at least one of bonding, gluing melting, riveting and fastening.

15. A method for sampling a fluid, the method comprising:
selecting a sampler that comprises an inlet that is fluidically linked to a vacuum compartment through a one-way intake valve and a storage compartment that is fluidically linked to the vacuum compartment through a one-way exit valve, and a plunger for intaking a sample through the inlet into the vacuum compartment and then pushing the sample into the storage compartment;
upstroking the plunger to intake the sample; and
downstroking the plunger to push the sample into a storage compartment.

16. The method as in claim 15, further comprising disconnecting a sampling tube from the inlet and optionally sealing the inlet.

17. The method as in claim 15, further comprising locking down the plunger by pushing a head of the plunger below at least one locking tab on a body of the sampler.

18. The method as in claim 17, wherein locking down the plunger seals at least one vent of the sampler.

19. The method as in claim 15, further comprising sealing a carrier box about a body of the sampling apparatus.
